(19) United States
(12) Patent Application Publication
(10) Pub. No.: US 2014/0278472 A1
(43) Pub. Date: Sep. 18, 2014

(54) INTERACTIVE HEALTHCARE MODELING WITH CONTINUOUS CONVERGENCE

(71) Applicant: Archimedes, Inc., (US)

(72) Inventor: ADAM GUETZ, Oakland, CA (US)

(73) Assignee: Archimedes, Inc., San Francisco, CA (US)

(21) Appl. No.: 13/841,118

(22) Filed: Mar. 15, 2013

(51) Int. Cl. G06Q 50/22; G06Q 10/10

(52) U.S. Cl. CPC G06Q 50/22; G06Q 10/10
USPC 705/2

(57) ABSTRACT

A method comprises receiving a prediction request that comprises a target patient population definition; in response to receiving the prediction request, performing in real-time: parsing the prediction request to identify the target patient population definition; mapping the one or more target patient population characteristics to a function of one or more input variables of a particular dataset, from a plurality of datasets; computing a weighted subset of patients; based, at least in part, on the target patient population definition and the particular dataset; computing the prediction data based on the weighted subset of patients; returning the prediction data.

### TECHNICAL FIELD

The present disclosure generally relates to using computers for interactive healthcare modeling and for predicting health and economic effects of healthcare interventions.

### BACKGROUND

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

Computer program applications have been developed to provide predictions of health care outcomes of various patient populations. However, generating the predictions is often resource-demanding because it usually requires running computationally expensive simulations, accessing large amounts of data and performing complex data analyses, all of which require significant data processing and storing power.

Further, due to its complexity, generating predictions may take a great deal of time, causing a significant delay in providing the prediction results to a user. However, the delay is highly undesirable because a user would expect the system to be interactive to a large degree, and would prefer to receive the predictions rapidly.

Interactivity of a prediction system is also important to a user in terms of the ability to repeatedly request modifications and receive results to each of the modified requests in an interactive fashion. A convenient and user-friendly manner in which the user may interact with the prediction system makes it easier for the user to determine how even small changes in patient population characteristics may potentially impact health care outcomes and risk factors.

### BRIEF DESCRIPTION OF THE DRAWINGS

In the drawings:

FIG. 1 illustrates a system on which an embodiment may be implemented;

FIG. 2 illustrates an example method for generating prediction data;

FIG. 3 illustrates an example computer system upon which an embodiment of the approach may be implemented.

### DESCRIPTION OF EXAMPLE EMBODIMENTS

Approaches for estimating healthcare costs and benefits for individuals are described. In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention. Embodiments are described herein according to the following outline:
1.0 General Overview
2.0 Structural and Functional Overview
3.0 Generating Prediction Data
4.0 Generating a Weighted Subset of Patients
5.0 Example of Generating a Weighted Subset of Patients
6.0 Implementation Mechanisms—Hardware Overview

1.0 General Overview

In an embodiment, a computer-implemented method comprises receiving a prediction request that comprises a target patient population definition. A prediction request may comprise a variety of requests and criteria further specifying the request. For example, the prediction request may comprise a request to predict health care outcomes for individuals of a target patient population.

In an embodiment, in response to receiving the prediction request, the following is performed in real-time: the prediction request is parsed to identify the target patient population definition; a weighted subset of individuals is computed to match the target patient population definition; prediction data is determined by computing weighted statistics; and the prediction data is returned.

In an embodiment, the prediction request comprises a request to predict population-level statistics of a target patient population of interest.

In an embodiment, a computer-implemented method comprises receiving a plurality of combinations of input variables, each of the plurality of combinations of input variables comprising health data. The method also comprises retrieving, from a plurality of healthcare models, a particular healthcare model that accepts the plurality of combinations of input variables.

In an embodiment, the plurality of combinations of input variables comprises any one of: population-related data and treatment-scenario data.

In an embodiment, the plurality of combinations of input variables comprises any one data of: treatment data, biomarkers data, disease risk data and demographic data.

In an embodiment, a method is performed by one or more computing devices.

The foregoing and other features and aspects of the disclosure will become more readily apparent from the following detailed description of various embodiments.

2.0 Structural and Functional Overview

FIG. 1 illustrates a computer system 100 on which an embodiment may be implemented. The system 100 comprises a data processing apparatus 110, and a database 150. The processing apparatus 110 is communicatively coupled with a requestor computer 120, from which the processing apparatus receives one or more prediction requests 130, and to which the processing apparatus 100 transmits one or more predictions 140.

In an embodiment, a requestor computer 120 is configured to receive from a user a prediction request 130, and transmit the prediction request to processing apparatus 110. A user may be a patient who uses the system 100, a healthcare professional, a healthcare provider manager and other entity that may use the system 100. A prediction request 130 may be provided via a web browser launched on requestor computer 120, via a command line entered on the requestor computer, or provided in any other form in which the requestor computer may accept data input.

Requestor computer 120 may also be configured to receive a prediction 140 from processing apparatus 110, and communicate the received prediction to the sender of the prediction request 130. The prediction 140 may be received in a form of a webpage that can be displayed in a web browser launched on requestor computer 120, or displayed in any other form in which the requestor computer may accept data input.

Requestor computer 120 may be part of a processing apparatus 110. Alternatively, a requestor computer 120 may be a user workstation executing a third-party software application configured to generate an application programming interface (API), from which a user may issue a prediction request.

Requestor computer 120 may be a workstation, a personal computer or a portable computing device. In an embodiment, the requestor computer 120 is configured to execute a web browser application for sending prediction requests to the processing apparatus 110, and receiving predictions from the processing apparatus 110.

In an embodiment, processing apparatus 110 comprises a processor 119, a dataset management unit 114, an interface handling unit 115, a request processor 116, and a converger unit 117. Processor 119 may comprise a general-purpose central processing unit (CPU).

Database 150 is coupled and accessible to at least the converger unit 117 and the dataset management unit 114. The database 150 comprises one or more patient datasets 157. Note that patient datasets 157 may originate from real-world observations or from computer simulations.

Processing apparatus 110 may be configured to receive a prediction request 130, generate an answer to the prediction request 130, and provide prediction 140. A prediction request 130 may comprise a target patient population definition. In an embodiment, a prediction request 130 is a request to predict health care statistics for a patient population specified in the target patient population definition.

Functionalities of processing apparatus 110 may be illustrated using the following example: suppose that a prediction request 130 was received. The prediction request 130 requests predictions for a population including male patients for whom a mean age value is forty-five years. In response to receiving the prediction request, processing apparatus 110 may attempt to predict mean biomarker values, long term health risks, the probability that the patients would experience myocardial infarctions within a specified time period, or other population-statistics related to health care risks and outcomes.

Interface handling unit 115 may be configured to receive, from requestor computer 120, a prediction request 130. Furthermore, interface handling unit 115 may be configured to receive, from request processor 116, prediction data. The prediction data may be obtained by request processor 116 in response to receiving the prediction request 130. Upon receiving the prediction data, interface handling unit 115 may process the prediction data to generate a prediction 140. For example, interface handling unit 115 may resolve any compatibility issues that may occur between the data format in which the prediction data is provided and the data format in which the prediction 140 may be provided to requestor computer 120.

In an embodiment, request processor 116 is coupled to the processor 119, and is configured to retrieve from database 150 a patient dataset that maps a plurality of combinations of input variables to patient variables. The patient dataset may be one of a plurality of patient datasets 157 stored in database 150.

Request processor 116 may also be configured to parse a prediction request 130 to identify a target patient population definition. In an embodiment, a patient population definition may define a particular patient population for whom to predict health care outcomes and risk factors.

Request processor 116 may also be configured to invoke a converger unit 117 and request that the converger unit 117 identify a plurality of patients in a patient dataset that match the target patient population definition included in a prediction request 130. For example, if a target patient population definition indicates a population comprising males, for whom a mean age value is 45 years, then request processor 116 may request that the converger unit 117 identify in the retrieved patient dataset a weighted subset of patients who are male and for whom a weighted mean age value is 45 years.

Converger unit 117 may cooperate with dataset management unit 114 to identify a certain group of patients. For example, upon receiving a target patient population definition and a patient dataset from request processor 116, converger unit 117 may request, from dataset management unit 114, data 157 that comprises data for patients. Converger unit 117 may also execute an algorithm that uses the target patient population definition provided by request processor 116, and maps the target patient population definition to a subset of the patient data in the patient dataset.

In an embodiment, converger unit 117 executes a fast running algorithm. The fast running algorithm may be designed for execution in a relatively efficient and optimized way. For example, the algorithm may be designed to return results in a timeframe that is acceptable to typical users. Examples of acceptable timeframes may include ten (10) seconds. In other implementations, depending on the requirement specification provided to processing apparatus 110, the timeframe may be longer or shorter than ten seconds.

Examples of input variables may any data related to healthcare outcomes of a patient population. In particular, the plurality of input variables may include treatment data, biomarkers data, disease risk data, healthcare costing data, and demographic data.

Examples of patient variables may include disease event rates, risk data for various medical conditions, including risk data for myocardial infarction, stroke, organ failure, or other risk data. The patient variables may also include medical costs, life years, mortality rate and other information possibly outputted by the healthcare model.

Processor 119 may be configured to execute commands of the units 114-117, and facilitate communications between the units 114-117, database 150 and requestor computer 120, as well as execute other stored program instructions for other purposes.

3.0 Generating Prediction Data

FIG. 2 illustrates an example method for generating prediction data.

In step 220, a prediction request is received at a processing apparatus. The prediction request may be received from a user, a patient, a healthcare professional, a healthcare service provider, or any other entity that uses the presented approach. The prediction request may be received via a web browser and may contain data entered by the user into the web browser page.

A prediction request may be a query issued to a processing apparatus described in FIG. 1, and may comprise various types of information. For example, a prediction request may comprise a request to provide real-time estimates of certain health risks that may be anticipated for individuals in a particular patient population within a certain time period. Examples of such requests may include a request to provide real-time estimates of five (5) year-risks of myocardial infarction for male patients for whom a mean age value is 45 years.

In an embodiment, a prediction request comprises a target patient population definition. The target patient population definition defines target population-level characteristics of a population of patients for which real-time estimates of healthcare statistics are requested, such as statistics of factors, biomarkers, and disease history. For example, if a prediction request is to provide real-time estimates of five (5) year-risks of myocardial infarction for male patients for whom a mean age value is 45 years, then a target patient population definition specifies male patients for whom a mean age value is 45 years.

In step 230, a received prediction request is parsed and elements of the prediction request are identified. In the course of parsing the received prediction request, a target patient population definition may be identified in the request. As described above, the target patient population definition specifies a particular target population.

In step 250, one or more target patient population criteria are mapped to a function of the input variables in a patient dataset.

In step 240, a weighted subset of patients who match the target patient population definition is identified. For example, if the target patient population definition included in a received prediction request specifies male patients for whom a mean age value is 45 years, then, using the target patient population definition, a weighted subset of patients in the patient dataset that match the target patient population definition is identified. This step may be performed by executing a fast running algorithm that takes the target patient population definition received in the prediction request, and maps the definition to a weighted subset of the patients in the patient dataset. The process may be executed by converger unit 117 of FIG. 1. An example process of identifying a subset of patients is described in detail in other sections herein.

In step 270, prediction data is estimated using a weighted subset of patients. The estimation may be performed using various statistical data interpolation techniques. For example, the weighted mean of diastolic blood pressure or the weighted Kaplan-Meier estimate of five-year myocardial infarction risk may be computed using individual weights. Further, the estimation may utilize uncertainty quantification error margins and various statistical approaches.

In step 280, prediction data is provided to a user. The prediction data may be displayed in a web browser, which user launched on his computer, and from which the user issued a prediction request. For example, if a user launched a web browser on a requestor computer 120, as depicted in FIG. 1, then the prediction data may be displayed for the user in the same web browser on the requestor computer 120. The prediction data may be displayed on a separate web page, or as part of the same web page from which the user sent the prediction request. The prediction data may be presented in a form of a table, a graph, a spreadsheet, or any other form.

One of the objectives for implementing the approach illustrated in FIG. 2 is to implement the approach in such a way that a response time for generating prediction data from the system is as small as possible. This may be achieved by employing a fast converger in the process of generating a response to a prediction request. In an embodiment, a patient population selection algorithm, executed in step 240, may be implemented as a fast-running algorithm, also referred to as a fast converger. Application of the fast converger may significantly shorten the time for identifying a subset of patients that match a target patient population definition provided in a prediction request.

Efficient implementations of other components of the presented system may also positively contribute to reducing the system total response time. For example, some or each of steps 250-270, described above, may be executed by fast-running algorithms, and execution of such fast-running algorithms may decrease the total response time to some degree.

4.0 Generating a Weighted Subset of Patients

In an embodiment, a subset of patients is generated upon receiving a prediction request at a processing apparatus. Receiving a prediction request is described in step 220 of FIG. 2.

A prediction request may be a query issued to a processing apparatus and may comprise various types of information. For example, a prediction request may comprise a request to provide real-time estimates of certain health risks that may be anticipated for a certain target patient population within a certain time period.

In response to receiving a prediction request, an apparatus may perform several steps, such as the steps depicted in FIG. 2. The steps comprise parsing the received prediction request and identifying a target patient population definition in the parsed request.

A request may include a target patient population definition that defines a group of certain individuals. For example, a prediction request may include a target patient population definition which specifies a group of individuals for whom a mean age value is 45 years.

A target patient population definition may be used to determine a subset of patients in a patient dataset. For example, if the target patient population definition included in a received prediction request specifies male patients for whom a mean age value is 45 years, then, using the target patient population definition, a weighted subset of patients in the patient dataset that match the target patient population definition is identified. This step may be performed by executing a process that takes the target patient population definition received in the prediction request, and maps the definition to a subset of the patients in the patient dataset.

In an embodiment, a patient dataset comprises a matrix of individual-level data. A matrix of individual-level data comprises rows and columns, wherein a row corresponds to an individual, and a column correspond to values of variables associated with the individuals.

In an embodiment, a process of determining a weighted subset of patients comprises determining a set of population-level variable targets, one for each column in the matrix of individual-level data. The process also comprises determining a vector of individual weights from the variable targets, and using the vector to determine a weighted subset of patients for whom the prediction request is sought.

In an embodiment, weighted population-level variable targets are computed within a pre-specified tolerance of the targets. The weights may be optimized with respect to one or more pre-specified regularization criteria.

A set of weights can then be used to determine a subset of individuals who are representative of a target patient population with the specified targets. The set of weights may be computed to include the set of individuals with weights exceeding a particular threshold. Furthermore, determining the set of weights may comprise computing estimates for a representative population for which population-level variable statistics were not included in the targets, but which could be derived by computing weighted mean values.

In an embodiment, determining a weighted subset of patients who match a target patient population definition included in a prediction request may comprise porting input data into a translation-into-optimization program, and optimizing the translated input data by the translation-into-optimization program to generate a vector of individual-level weights.

Input data that is ported to a translation-into-optimization program, and may comprise data included in an individual-level data matrix and a set of targets.

An individual-level data matrix may be an N by p matrix, where N is the number of individuals, and p is the number of variables. Hence, the matrix entry (i,j) corresponds to the value of the j^{th} variable for the i^{th} individual.

A set of targets may be a set of population-level targets for variables specified in the individual-level data matrix.

A translation-into-optimization program may be implemented in a software application that is configured to accept input, such as an individual-level data matrix, a set of targets, and a target tolerance value, and translate the inputs into forms that may be processed by an optimization program solver.

An optimization program solver may be implemented in a software application configured to take, as input, output from a translation-into-optimization program, and generates a vector of individual level weights. The vector is an output solution, which is also referred to as an approximate solution. The optimization program solver may utilize various third-party software applications, such as applications developed by MOSEK, CVXOPT and GUROBI.

5.0 Example of Generating a Weighted Subset of Patients

In one embodiment, the process in this section may be used for generating a subset of patients for providing a prediction in response to receiving a prediction request.

In an embodiment, an empirical distribution is represented by a set of samples v={v₍ᵢ₎}ᵢ₌₁^{N}, where v₍ᵢ₎εΩ for some state-space Ω. For example, v₍ᵢ₎={v₍ᵢ₎_{ⱼ}}ⱼ₌^{k} may represent a patient in an epidemiological study, with v₍ᵢ₎_{ⱼ} corresponding to a continuous, binary or categorical biomarker. The set of samples is used to probe a “sub-population” of v, i.e., a set of samples v_{sub}⊂v conditioned on v_{sub} meeting some set of criteria C_{sub}, where C_{sub}={d(cₗ(v_{sub}),μₗ)}ₗ₌₁^{m} for conditional functions cₗ with target value μₗ and distance function d.

Examples of constraint functions may include the mean or variance of a biomarker matching a target, a percentage of biomarkers falling within a specified range, and conditional expectations of a biomarker conditioned on values of other biomarkers. An assumption may be made that an approximation, not an exact match, of the constraints is sought, and that the approximation is satisfied with minimizing Σₗ₌₁^{m}d(cₗ,μₗ).

Examples of possible linear constraints target functions are:

TABLE 1
Possible Linear Constraint Target Functions.

| function | formulation |
|---|---|
| mean | Σᵢ₌₁^{N}vᵢwᵢ |
| range γ | Σᵢ₌₁^{N}I_{viεγ}wᵢ |
| quantile q | Σᵢ₌₁^{N}I_{v≦q}wᵢ |
| second moment | Σᵢ₌₁^{N}vᵢ²wᵢ |
| variance* | converge on mean and second moment |

Examples of min-absolute value constraints violation LP are:

$$Sub \text{-} Program 1 \text{:} Min \text{-} absolute Value Constraint Violation LP . \\ min {q}^{+} + {q}^{-}$$

$$s . t . \\ {\sum }_{i = 1}^{N} {w}_{i} = 1$$

$$c ( w ) - q = μ$$

$$q = {q}^{+} - {q}^{-}$$

$$∀ i \text{:} {q}^{+} , {q}^{-} , {w}_{i} \geq 0$$

Examples of max-norm LP are:

$$Sub \text{-} Program 2 \text{:} Max \text{-} norm LP . \\ min q$$

$$s . t . \\ {\sum }_{i = 1}^{N} {w}_{i} = 1$$

$${w}_{i} \geq 0$$

$$∀ i \text{:} {w}_{i} \leq q$$

In an embodiment, the process finds the largest possible sub-population that best matches the constraints. The task may be accomplished by converger logic implemented as Program 1, below:

$$Program 1 : Optimal Empirical Conditional Distribution I P . \\ min - {\sum }_{i = 1}^{N} {w}_{i} + {\sum }_{l = 1}^{m} {( {c}_{l} ( w ) - {μ}_{l} )}^{2} / {σ}_{l}^{2}$$

$$s . t . \\ {w}_{i} ∈ \{ 0 , 1 \}$$

Program 1, also referred to as an Integer Program (IP), may implement a stochastic greedy algorithm. In some implementations, the stochastic greedy algorithm may be slow and fail to produce optimal results in a reasonable amount of time. Also, in some implementations, the running time of the algorithm may be expressed as a quadratic function of N, or even worse. Thus, for large N, the running time may be unacceptable. Moreover, the algorithm may fail to directly optimize the number of samples in the subpopulation, Σᵢ₌₁ⁿwᵢ; however, that may be guessed by a trial-and-error approach. For at least the above reasons, implementing Program 1 may be undesirable.

Alternatively, other optimization programs may be developed. Examples of those programs are described below.

In an embodiment, Program 2 is implemented as a converger tool. Program 2 implements a Linear Program (LP) formulation as follows:

$$Program 2 \text{:} Optimal Conditional Empirical Sampling LP . \\ min {α}_{o} {q}_{o} + {α}_{∞} {q}_{∞} + {α}_{1} {q}_{1}$$

$$s . t . \\ {\sum }_{i = 1}^{N} {w}_{i} = 1$$

$$∀ l \text{:} {\sum }_{i = 1}^{N} {c}_{li} {w}_{i} / {σ}_{l} - {q}_{l}^{+} + {q}_{l}^{-} = {μ}_{l} / {σ}_{l}$$

$$∀ l \text{:} {β}_{l} ( {q}_{l}^{+} + {q}_{l}^{-} ) - {q}_{∞} \leq 0$$

$$\frac{1}{m} {\sum }_{l = 1}^{m} {β}_{l} ( {q}_{l}^{+} + {q}_{l}^{-} ) - {q}_{1} = 0$$

$$∀ i \text{:} {w}_{i} - {q}_{0} \leq 0$$

$$∀ l \text{:} {q}_{l}^{+} , {q}_{l}^{-} \geq 0$$

$$∀ i \text{:} {w}_{i} \geq 0$$

Program 2 may be used to perform a conditional empirical sampling using an off-the-shelf interior point LP solver, which implements linearization of some of the constraint and objective functions using either L1 or L∞ norms (or both).

In an embodiment, Program 3 is used to implement a converger tool. Program 3 implements a quadratic program (QP) as follows:

$$Program 3 \text{:} Optimal Conditional Empirical Sampling QP . \\ min {α}_{0} {\sum }_{i = 1}^{N} {w}_{i}^{2} + {α}_{2} \sum {β}_{l} {q}_{l}^{2}$$

$$s . t . \\ {\sum }_{i = 1}^{N} {w}_{i} = 1$$

$$∀ l \text{:} {\sum }_{i = 1}^{N} {c}_{li} {w}_{i} / {σ}_{l} - {q}_{l} = {μ}_{l} / {σ}_{l}$$

$$∀ i \text{:} {w}_{i} \geq 0$$

Program 3 is a more natural program to optimize, although it may be more difficult to solve Program 3 than Program 1 LP. Again, off-the-shelf solvers can be used here.

In an embodiment, Program 4 is used to implement a converger tool. Program 4 implements integral solutions, and is referred to herein as a Mixed Integer Linear (MILP) Program as follows:

$$Program 4 \text{:} Optimal Conditional Empirical Sampling M I L P - \\ L 1 and L ∞ constraints . \\ min - s$$

$$s . t . \\ {\sum }_{i = 1}^{N} {w}_{i} = s$$

$$∀ l \text{:} {\sum }_{i = 1}^{N} {c}_{li} {w}_{i} / {σ}_{l} - {μ}_{l} {q}_{0} / {σ}_{l} - {q}_{1}^{( l ) +} , {q}_{1}^{( l ) -} = 0$$

$$∀ l \text{:} {q}_{1}^{( l ) +} , {q}_{1}^{( l ) -} \geq 0$$

$${\sum }_{l = 1}^{m} {β}^{( l )} ( {q}_{1}^{( l ) +} + {q}_{1}^{( l ) -} ) - {γ}_{1} s \leq 0$$

$$∀ l \text{:} {β}^{( l )} ( {q}_{1}^{( l ) +} + {q}_{1}^{( l ) -} ) \leq {γ}_{∞}$$

$$∀ i \text{:} {w}_{i} ∈ \{ 0 , 1 \}$$

Alternatively, off-the-shelf MILP solvers may be used.

In an embodiment, Program 5 is used to implement a converger tool. Program 5 implements an optimal conditional empirical sampling MILP as follows:

$$Program 5 \text{:} Optimal Conditional Empirical Sampling M I L P - \\ min L ∞ , L 1 Tolerance . \\ min - s + {α}_{∞} {q}_{∞}$$

$$s . t . \\ {\sum }_{i = 1}^{N} {w}_{i} = s$$

$$∀ l \text{:} {\sum }_{i = 1}^{N} {c}_{li} {w}_{i} / {σ}_{l} - {μ}_{l} {q}_{0} / {σ}_{l} - {q}_{1}^{( l ) +} + {q}_{1}^{( l ) -} = 0$$

$$∀ l \text{:} {q}_{1}^{( l ) +} , {q}_{1}^{( l ) -} \geq 0$$

$$\frac{1}{m} {\sum }_{l = 1}^{m} {β}^{( l )} ( {q}_{1}^{( l ) +} + {q}_{1}^{( l ) -} ) - {q}_{1} = 0$$

$$∀ l \text{:} {β}^{( l )} ( {q}_{1}^{( l ) +} + {q}_{1}^{( l ) -} ) - {q}_{∞} \leq 0$$

$${q}_{∞} - {γ}_{∞} \leq 0$$

$${q}_{1} - {γ}_{1} s \leq 0$$

$$∀ i \text{:} {w}_{i} ∈ \{ 0 , 1 \}$$

In an embodiment, a converger tool formulates constraints as weighted averages of sample values. For example, referring to constraint functions in Table 1, above, instead of using 0-1 weights in Program 1, the weights w, may be used to hold continuous values. The weights should sum to “1.” The approach for determining weighted averages of sample values may be implemented using Program 6, below:

$$Program 6 \text{:} Optimal Empirical Conditional Distribution N L P . \\ min r ( w ) + {\sum }_{l = 1}^{m} d ( {c}_{l} ( v , w ) , {μ}_{l} ) / {σ}_{l}^{2}$$

$$s . t . \\ {w}_{i} \geq 0$$

$${\sum }_{i = 1}^{N} {w}_{i} = 1$$

In Program 6, r(w) is a “regularization” function such as r(w)=−Σᵢ₌₁^{N}wᵢ². The weights may be determined as Dirichlet distributions over samples.

In an embodiment, Program 6 uses continuous relaxations of integer programs that are often useful in constructing approximate solutions to the integer program. In other implementations, Program 6 may use rounding, sampling, cutting plane, branch/bound, or ordering approaches as alternatives to IP. Solutions to continuous relaxation serve as a lower bound to the IP, and therefore act as a practical benchmark for IP solvers.

In an embodiment, a conditional sampling may be used as an inverse problem. According to this approach, it is assumed that samples v come from some biased distribution g, such that g(v)=b(v)f(v). Here, b is a biasing or conditioning function that represents the selection process that transformed f into g. For example, g may represent the biomarker distribution of a clinical trial, and b may represent some preferential inclusion/exclusion process that the trial investigators imposed. It is assumed that b has some parametric form, and a model of b may be built based on knowledge of how bias was introduced to the sampling process. A parametric form for b may be derived to represent the biasing process. However, since the knowledge about the bias introduced to a sampling process is represented by population-level statistics, making parametric assumptions is not necessary (unless it is explicitly desired).

Refraining from making parametric assumptions is referred herein to as non-parametric statistics. Some of the applicable approaches include conditional empirical distributions (also called biased or weighted empirical distributions). The conditional sampling process may be the Dirichlet process with weights w, expressed as:

ĝ_{N}(v)=Σᵢ₌₁_{_{N}}Iᵥ₌ᵥᵢwᵢ (1)

The best set of weights w, may be found using the optimization programs described above.

In an embodiment, the optimization programs implement a convergence-to-true-conditional-distribution. If the set of constraint functions {cₗ}ₗ₌^{m} defines a sufficient statistic for b(v)f(v), and b(v)f(v) is sufficiently smooth (with a countable number of discontinuities), then ĝ_{N}(v)→g(v) as N→∞.

Alternatively, this may be specified in terms of expected values. Let x be the random variable distributed according to the unbiased distribution f, x˜f, and let y˜g. Furthermore, let for any function h:Ω→ [symbol] (wcmd), wherein “wcmd” means “with countably many discontinuities,” sufficient constraint functions {cᵢ}ᵢ₌₁_{ₘ}, biasing function b (wcmd), exist. Then E[h(x)ĝ_{N}(x)]→E[h(y)] as N→∞. This states that for any function of interest of the data h, the expected value of h computed with conditional empirical distribution will converge to the “true” expected value within the limit.

To use the target functions in Table 1 as constraints, the distance from the cⱼ(w) to the target μⱼ needs to be minimized. The distance either takes the form of absolute value, d₁(a,b)=|a−b|, or the squared difference, d₂(a,b)=(a−b)². A benefit of using absolute value is that it can be formulated as a linear program. Benefits of the quadratic form d₂ are that it is smooth, and that it more strongly penalizes large deviations so that deviations tend to be spread more evenly over the constraints.

The case of the variance function, var(v)=E[v²]−E[v]², is quadratic. Therefore, it cannot be coded as a linear constraint. However, it can be converged on the first and second moments and therefore indirectly converged on the variance.

In an embodiment, one of the purposes of implementing a regularization term r(w) is to “disperse” the sample weights as much as possible, so that the sample population v is used much as possible to construct the estimators. Two types of regularization terms are considered: a max-norm (which is linear), and a quadratic term.

If the objective is to minimize a quadratic regularization term, such as:

r_{q}(w)=Σᵢ₌₁^{N}wᵢ², (2)

then that is equivalent to maximizing the effective sample size:

$$E S S = \frac{1}{{\sum }_{i = 1}^{N} {w}_{i}^{2}} \qquad ( 3 )$$

which is a standard metric for biased sampling that approximately gives the equivalent number of samples drawn from the conditional distribution. ESS can be used to build rough confidence intervals for expected value estimation.

An alternative regularization term may be L^{∞}, or max norm, expressed as:

r_{∞}(w)=maxᵢwᵢ. (4)

This formulation discourages weights from accruing to one or a few samples.

If the constraint functions are restricted to be linear (as from Table 1) and the max-norm regularization function is used, then the optimization problem can be formulated as a Linear Program (LP). However, if the quadratic regularization function is used and/or quadratic distance functions for constraints are used, then the optimization problem can be formulated as a convex Quadratic Program (QP).

Typically, solving the LP appears to be faster than solving the QP. However, this may not always be the case. In some embodiments, a hybrid approach is used, in which the solution to the LP is used as the initial point, and then combined with the QP solver.

A Linear Program may be formulated by the min max-norm LP 2 with a Program 1 LP, above, for each constraint. This is formulated in Program 2, above. The constants are: cₗᵢ=cₗ(vᵢ), αₒ is a weighting parameters for the max-norm term, and βₗ is a weighting parameter for each constraint cₗ.

To feasibly solve large-scale linear programs, it is necessary to use sparse representations when possible. Almost all LP solvers do this naturally for upper bound and lower bound constraints. If these were to be represented in dense inequality matrix form, then it would take O(n²) operations to evaluate the feasibility of a solution, whereas in sparse representation it takes O(n). However, general sparse constraint matrices are not as well supported. With this in mind, the wᵢ−q₀≦0 constraints in Program 2 can be rewritten as an upper bound constraint wᵢ≦q₀ with q₀ held constant, and the α₀q₀ objective removed. This formulation is given in Program 7, as follows:

$$Program 7 \text{:} Optimal Conditional Empirical Sampling L P - no$$

$$sparse matrix constraints . min {α}_{∞} {q}_{∞} + {α}_{1} {q}_{1}$$

$$s . t . \\ {\sum }_{i = 1}^{N} {w}_{i} = 1$$

$$∀ l \text{:} {\sum }_{i = 1}^{N} {c}_{li} {w}_{i} / {σ}_{l} - {q}_{l}^{+} + {q}_{l}^{-} = {μ}_{l} / {σ}_{l}$$

$$∀ l \text{:} {β}_{l} ( {q}_{l}^{+} + {q}_{l}^{-} ) - {q}_{∞} \leq 0$$

$$\frac{1}{m} {\sum }_{l = 1}^{m} {β}_{l} ( {q}_{l}^{+} + {q}_{l}^{-} ) - {q}_{1} = 0$$

$$∀ i \text{:} {w}_{i} \leq {q}_{o}$$

$$∀ l \text{:} {q}_{l}^{+} , {q}_{l}^{-} \geq 0$$

$$∀ i \text{:} {w}_{i} \geq 0$$

Using the approach of Program 7, execution of the LP may be repeated multiple times to perform a binary search on q₀ to find a maximum value q₀ for which a feasible solution exists. This leads to determining a weighted subset of the patient dataset for a prediction request.

If an unweighted subset of the patient dataset is required, weights may also be rounded to the nearest value of 0 or q₀.

6.0 Implementation Mechanics—Hardware Overview

FIG. 3 is a block diagram that illustrates a computer system 300 upon which an embodiment of the invention may be implemented. Computer system 300 includes a bus 302 or other communication mechanism for communicating information, and a processor 304 coupled with bus 302 for processing information. Computer system 300 also includes a main memory 306, such as a random access memory (RAM) or other dynamic storage device, coupled to bus 302 for storing information and instructions to be executed by processor 304. Main memory 306 also may be used for storing temporary variables or other intermediate information during execution of instructions to be executed by processor 304. Computer system 300 further includes a read only memory (ROM) 308 or other static storage device coupled to bus 302 for storing static information and instructions for processor 304. A storage device 310, such as a magnetic disk or optical disk, is provided and coupled to bus 302 for storing information and instructions.

Computer system 300 may be coupled via bus 302 to a display 312, such as a cathode ray tube (CRT), for displaying information to a computer user. An input device 314, including alphanumeric and other keys, is coupled to bus 302 for communicating information and command selections to processor 304. Another type of user input device is cursor control 316, such as a mouse, a trackball, or cursor direction keys for communicating direction information and command selections to processor 304 and for controlling cursor movement on display 312. This input device typically has two degrees of freedom in two axes, a first axis (e.g., x) and a second axis (e.g., y), that allows the device to specify positions in a plane.

The invention is related to the use of computer system 300 for implementing the techniques described herein. According to an embodiment of the invention, those techniques are performed by computer system 300 in response to processor 304 executing one or more sequences of one or more instructions contained in main memory 306. Such instructions may be read into main memory 306 from another machine-readable medium, such as storage device 310. Execution of the sequences of instructions contained in main memory 306 causes processor 304 to perform the process steps described herein. In alternative embodiments, hard-wired circuitry may be used in place of or in combination with software instructions to implement the invention. Thus, embodiments of the invention are not limited to any specific combination of hardware circuitry and software.

The term “machine-readable medium” as used herein refers to any medium that participates in providing data that causes a machine to operate in a specific fashion. In an embodiment implemented using computer system 300, various machine-readable media are involved, for example, in providing instructions to processor 304 for execution. Such a medium may take many forms, including but not limited to storage media and transmission media. Storage media includes both non-volatile media and volatile media. Non-volatile media includes, for example, optical or magnetic disks, such as storage device 310. Volatile media includes dynamic memory, such as main memory 306. Transmission media includes coaxial cables, copper wire and fiber optics, including the wires that comprise bus 302. Transmission media can also take the form of acoustic or light waves, such as those generated during radio-wave and infra-red data communications. All such media must be tangible to enable the instructions carried by the media to be detected by a physical mechanism that reads the instructions into a machine.

Common forms of machine-readable media include, for example, a floppy disk, a flexible disk, hard disk, magnetic tape, or any other magnetic medium, a CD-ROM, any other optical medium, punch cards, paper tape, any other physical medium with patterns of holes, a RAM, a PROM, and EPROM, a FLASH-EPROM, any other memory chip or cartridge, a carrier wave as described hereinafter, or any other medium from which a computer can read.

Various forms of machine-readable media may be involved in carrying one or more sequences of one or more instructions to processor 304 for execution. For example, the instructions may initially be carried on a magnetic disk of a remote computer. The remote computer can load the instructions into its dynamic memory and send the instructions over a telephone line using a modem. A modem local to computer system 300 can receive the data on the telephone line and use an infra-red transmitter to convert the data to an infra-red signal. An infra-red detector can receive the data carried in the infra-red signal and appropriate circuitry can place the data on bus 302. Bus 302 carries the data to main memory 306, from which processor 304 retrieves and executes the instructions. The instructions received by main memory 306 may optionally be stored on storage device 310 either before or after execution by processor 304.

Computer system 300 also includes a communication interface 318 coupled to bus 302. Communication interface 318 provides a two-way data communication coupling to a network link 320 that is connected to a local network 322. For example, communication interface 318 may be an integrated services digital network (ISDN) card or a modem to provide a data communication connection to a corresponding type of telephone line. As another example, communication interface 318 may be a local area network (LAN) card to provide a data communication connection to a compatible LAN. Wireless links may also be implemented. In any such implementation, communication interface 318 sends and receives electrical, electromagnetic or optical signals that carry digital data streams representing various types of information.

Network link 320 typically provides data communication through one or more networks to other data devices. For example, network link 320 may provide a connection through local network 322 to a host computer 324, or to data equipment operated by an Internet Service Provider (ISP) 326. ISP 326 in turn provides data communication services through the world wide packet data communication network now commonly referred to as the “Internet” 328. Local network 322 and Internet 328 both use electrical, electromagnetic or optical signals that carry digital data streams. The signals through the various networks and the signals on network link 320 and through communication interface 318, which carry the digital data to and from computer system 300, are exemplary forms of carrier waves transporting the information.

Computer system 300 can send messages and receive data, including program code, through the network(s), network link 320 and communication interface 318. In the Internet example, a server 330 might transmit a requested code for an application program through Internet 328, ISP 326, local network 322 and communication interface 318.

The received code may be executed by processor 304 as it is received, and/or stored in storage device 310, or other non-volatile storage for later execution. In this manner, computer system 300 may obtain application code in the form of a carrier wave.

In the foregoing specification, embodiments of the invention have been described with reference to numerous specific details that may vary from implementation to implementation. Thus, the sole and exclusive indicator of what is the invention, and is intended by the applicants to be the invention, is the set of claims that issue from this application, in the specific form in which such claims issue, including any subsequent correction. Any definitions expressly set forth herein for terms contained in such claims shall govern the meaning of such terms as used in the claims. Hence, no limitation, element, property, feature, advantage or attribute that is not expressly recited in a claim should limit the scope of such claim in any way. The specification and drawings are, accordingly, to be regarded in an illustrative rather than a restrictive sense.

1.-5. (canceled)

6. A data processing method, comprising:
receiving a prediction request for providing estimates of health risks that may be anticipated in individuals who have one or more target patient population characteristics;
in response to receiving the prediction request, using the prediction request, identifying the one or more target patient population characteristics;
using a mapping function, determining a particular set of patients having one or more individual characteristics that correspond to the one or more target patient population characteristics within a tolerance range;
computing, for the particular set of patients, one or more weights that indicate how well the one or more individual characteristics match the one or more target patient population characteristics;
based, at least in part, on the one or more weights, selecting, from the particular set of patients, a weighted subset of patients whose computed weights exceed a threshold value;
retrieving, from a plurality of healthcare models, a particular healthcare model that accepts data of the weighted subset of patients;
determining prediction data by estimating, using the particular healthcare model, simulation results that a simulation based on the particular healthcare model would yield for the weighted subset of patients;
wherein the method is performed by one or more computing devices.

7. The method of claim 6, comprising identifying the weighted subset of patients by determining a largest possible patient sub-population that best matches the one or more target patient population characteristics.

8. The method of claim 6, wherein the one or more target patient population characteristics define target population-level characteristics of the individuals;
wherein the target population-level characteristics include any one of: statistical information, biomarkers, or disease history data.

9. The method of claim 6, wherein the weighted subset of patient is a weighted subset of virtual individuals selected from a plurality of virtual patients in a patient database.

10. The method of claim 6, wherein the prediction request specifies estimates of health risks that may be anticipated in the individuals within a certain time period.

11. The method of claim 6, comprising determining the weighted subset of patients using one or more data optimization approaches.

12. The method of claim 6, comprising computing the one or more weights using a converger tool that is configured to formulate constraints for data records of patients of the particular set of patients.

13. A non-transitory computer-readable storage medium storing one or more sequences of instructions which, when executed by one or more processors, cause the one or more processors to perform:
receiving a prediction request for providing estimates of health risks that may be anticipated in individuals who have one or more target patient population characteristics;
in response to receiving the prediction request, using the prediction request, identifying the one or more target patient population characteristics;
using a mapping function, determining a particular set of patients having one or more individual characteristics that correspond to the one or more target patient population characteristics within a tolerance range;
computing, for the particular set of patients, one or more weights that indicate how well the one or more individual characteristics match the one or more target patient population characteristics;
based, at least in part, on the one or more weights, selecting, from the particular set of patients, a weighted subset of patients whose computed weights exceed a threshold value;
retrieving, from a plurality of healthcare models, a particular healthcare model that accepts data of the weighted subset of patients;
determining prediction data by estimating, using the particular healthcare model, simulation results that a simulation based on the particular healthcare model would yield for the weighted subset of patients.

14. The non-transitory computer-readable storage medium of claim 13, comprising instructions which, when executed, cause identifying the weighted subset of patients by determining a largest possible patient sub-population that best matches the one or more target patient population characteristics.

15. The non-transitory computer-readable storage medium of claim 13, wherein the one or more target patient population characteristics define target population-level characteristics of the individuals; wherein the target population-level characteristics include any one of: statistical information, biomarkers, or disease history data.

16. The non-transitory computer-readable storage medium of claim 13, wherein the weighted subset of patient is a weighted subset of virtual individuals selected from a plurality of virtual patients in a patient database.

17. The non-transitory computer-readable storage medium of claim 13, wherein the prediction request specifies estimates of health risks that may be anticipated in the individuals within a certain time period.

18. The non-transitory computer-readable storage medium of claim 13, comprising instructions which, when executed, cause determining the weighted subset of patients using one or more data optimization approaches.

19. The non-transitory computer-readable storage medium of claim 13, comprising instructions which, when executed, cause computing the one or more weights using a converger tool that is configured to formulate constraints for data records of patients of the particular set of patients.

20. An apparatus, comprising:
one or more processors;
a request processor coupled to the one or more processors, and configured to perform:
receiving a prediction request for providing estimates of health risks that may be anticipated in individuals who have one or more target patient population characteristics;
in response to receiving the prediction request, using the prediction request, identifying the one or more target patient population characteristics;
using a mapping function, determining a particular set of patients having one or more individual characteristics that correspond to the one or more target patient population characteristics within a tolerance range;
computing, for the particular set of patients, one or more weights that indicate how well the one or more individual characteristics match the one or more target patient population characteristics;
based, at least in part, on the one or more weights, selecting, from the particular set of patients, a weighted subset of patients whose computed weights exceed a threshold value;
retrieving, from a plurality of healthcare models, a particular healthcare model that accepts data of the weighted subset of patients;
determining prediction data by estimating, using the particular healthcare model, simulation results that a simulation based on the particular healthcare model would yield for the weighted subset of patients.

21. The apparatus of claim 20, the request processor is configured to perform identifying the weighted subset of patients by determining a largest possible patient sub-population that best matches the one or more target patient population characteristics.

22. The apparatus of claim 20, wherein the one or more target patient population characteristics define target population-level characteristics of the individuals;
wherein the target population-level characteristics include any one of: statistical information, biomarkers, or disease history data.

23. The apparatus of claim 20, wherein the weighted subset of patient is a weighted subset of virtual individuals selected from a plurality of virtual patients in a patient database.

24. The apparatus of claim 20, wherein the prediction request specifies estimates of health risks that may be anticipated in the individuals within a certain time period.

25. The apparatus of claim 20, the request processor is configured to perform determining the weighted subset of patients using one or more data optimization approaches.
